(19) United States
(12) Patent Application Publication
(10) Pub. No.: US 2020/0113760 A1
(43) Pub. Date: Apr. 16, 2020

(54) ELECTRIC FURNITURE

(71) Applicant: PARAMOUNT BED CO., LTD., Tokyo (JP)

(72) Inventors: Tomoki YOSHIDA, Koto-ku Tokyo (JP); Yuji HOSOKAWA, Koto-ku Tokyo (JP); Masato SHIMOKAWA, Koto-ku Tokyo (JP)

(21) Appl. No.: 16/482,185

(22) PCT Filed: Apr. 18, 2018
(86) PCT No.: PCT/JP2018/015968

§ 371 Date: Jul. 30, 2019

(30) Foreign Application Priority Data
May 1, 2017 (JP) 2017-091077

(51) Int. Cl. A61G 7/018; A61G 7/015; A61G 7/012

(52) U.S. Cl. CPC A61G 7/018; A61G 7/015; A61G 2203/44; A61G 2203/12; A61G 7/012

(57) ABSTRACT

According to an embodiment, electric furniture includes a controlled part, a detector, and a controller. The detector detects a state of a user. The controller controls the controlled part based on the state of the user detected by the detector. Electric furniture is provided in which the ease of use can be improved.

### TECHNICAL FIELD

An embodiment of the invention relates to electric furniture.

### BACKGROUND ART

For example, there are electric furniture (e.g., an electric bed, an electric reclining chair, etc.) that can modify an angle of a backrest and/or a height. These electric furniture are operated by a control device (e.g., a remote controller: remote control) such as a handy switch, etc. It is desirable to improve the ease of use of such a control device.

### PRIOR ART DOCUMENTS

### Patent Literature

[Patent Literature 1]

JP-A H11-235363 (Kokai)

### SUMMARY OF INVENTION

### Problem to be Solved by the Invention

An embodiment of the invention provides electric furniture in which the ease of use can be improved.

### Means for Solving the Problem

According to an embodiment, electric furniture includes a controlled part, a detector, and a controller. The detector detects the state of a user. The controller controls the controlled part based on the state of the user detected by the detector.

### Effects of the Invention

An embodiment of the invention can provide electric furniture in which the ease of use can be improved.

### BRIEF DESCRIPTION OF DRAWINGS

FIG. 1A to FIG. 1C are schematic perspective views illustrating electric furniture according to a first embodiment.

FIG. 2A to FIG. 2E are schematic views illustrating controls of the electric furniture according to the first embodiment.

FIG. 3 is a block diagram illustrating the electric furniture according to the first embodiment.

FIG. 4A to FIG. 4D are schematic views illustrating states of the electric furniture according to the first embodiment.

FIG. 5 is a schematic perspective view illustrating the electric furniture according to the first embodiment.

FIG. 6 is a schematic perspective view illustrating the electric furniture according to the first embodiment.

FIG. 7 is a schematic perspective view illustrating electric furniture according to a second embodiment.

FIG. 8A and FIG. 8B are schematic views illustrating the electric furniture according to the second embodiment.

FIG. 9A to FIG. 9D are schematic views illustrating another electric furniture according to the second embodiment.

FIG. 10 is a schematic perspective view illustrating electric furniture according to a third embodiment.

### MODES FOR CARRYING OUT THE INVENTION

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with the same reference numerals; and a detailed description is omitted as appropriate.

### First Embodiment

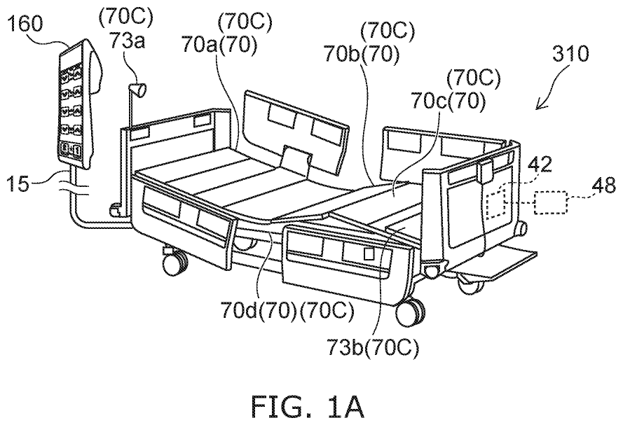

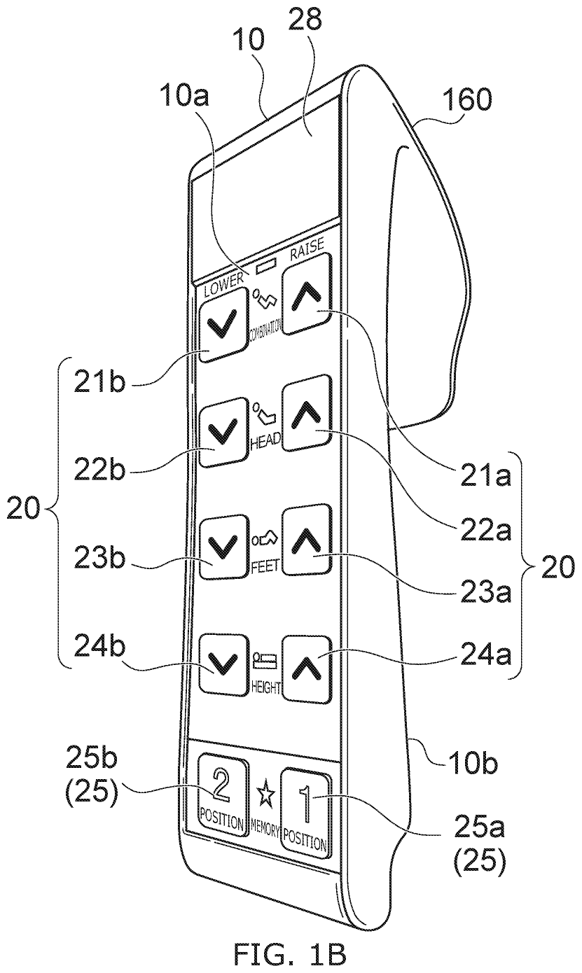

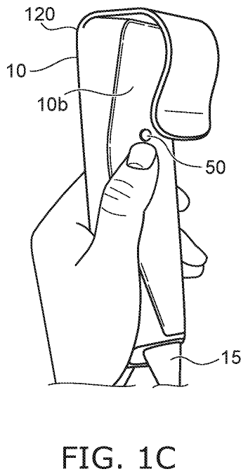

FIG. 1A to FIG. 1C are schematic perspective views illustrating electric furniture according to a first embodiment.

As shown in FIG. 1A, the electric furniture 310 according to the first embodiment includes a controlled part 70C. The controlled part 70C includes, for example, a movable part 70. The controlled part 70C may include at least one of the movable part 70, an illuminator 73a, or a temperature controller 73b (e.g., a heater, etc.). In the example, a control device 160 is provided in the electric furniture 310. The control device 160 can control the movable part 70 of the electric furniture 310. The control device 160 is, for example, a remote controller (a remote control) of the electric furniture 310. The control device 160 is, for example, a handy switch. The control device 160 may include various functions such as an ON/OFF function of lighting, a paging function of a nurse or a caregiver, an ON/OFF function of a power supply, etc.

For example, the electric furniture 310 is used in a hospital, a care facility, a household, etc.

In the example, the electric furniture 310 is an electric bed. The electric bed includes the movable part 70. The movable part 70 includes, for example, a back section 70a, an upper leg section 70b, a lower leg section 70c, a height adjuster 70d (e.g., a bed raiser/lowerer), etc. The angles between the back section 70a, the upper leg section 70b, and the lower leg section 70c are modifiable. The angle of the back of the user is modifiable by the operation of the back section 70a. The angle of the knees is modifiable by modifying the angle between the upper leg section 70b and the lower leg section 70c. These angles may be changed in combination. For example, the height adjuster 70d can modify the distance (the height) between the floor surface and the bed surface. The height adjuster 70d may be capable of independently modifying the height on the head side of the bed and the height on the foot side of the bed. The tilt of the entire bed surface can be modified thereby. These movable parts 70 include, for example, actuators, etc. By the operations of the movable parts 70, at least one of “back-raising,” “knee-raising,” “height adjustment,” “tilting,” or the like is possible. “Tilting” includes at least one of rolling or tilting.

The control device 160 is electrically connected to the movable part 70 recited above. A control circuit may be provided between the control device 160 and the movable part 70. Thus, the case where another circuit is provided therebetween also is included in the state of being electrically connected.

As shown in FIG. 1A, the control device 160 is connected to the electric furniture 310 by a cable 15. The control device 160 may be connected to the electric furniture 310 by wireless communication. The control device 160 includes an operation part 10.

As shown in FIG. 1B and FIG. 1C, the control device 160 (the operation part 10) has a first surface 10a and a second surface 10b. The second surface 10b is the surface on the side opposite to the first surface 10a. The first surface 10a is, for example, the surface on the front side. The second surface 10b is, for example, the back surface. The first surface 10a is, for example, the operation surface.

The control device 160 includes a first operation acceptor 20 (e.g., multiple operation buttons), a second operation acceptor 25 (e.g., a memory button), and a switch 50.

The first operation acceptor 20 (e.g., the multiple operation buttons) and the second operation acceptor 25 (e.g., the memory button) are provided at the first surface 10a. For example, the switch 50 is provided at a part other than the first surface 10a. In the example, the switch 50 is provided at the second surface 10b. The switch 50 may be provided at a side surface of the housing of the control device 160.

The first operation acceptor 20 and the second operation acceptor 25 include, for example, switches (e.g., buttons) including mechanical contact points. Other than switches including mechanical contact points, the first operation acceptor 20 and the second operation acceptor 25 may include any input device (e.g., touch switches, etc.) of an electrostatic type, an optical type, etc.

The first operation acceptor 20 (e.g., the multiple operation buttons) and the second operation acceptor 25 (e.g., the memory button) can accept control operations controlling the operations of the movable part 70 of the electric furniture 310.

The movable part 70 is controlled based on the control operations accepted by the first operation acceptor 20 and the second operation acceptor 25. The movable part 70 is operated by operating the first operation acceptor 20. The movable part 70 is set to a stored state by operating the second operation acceptor 25. For example, the stored state is stored in memory 48 (referring to FIG. 1A).

In the example, the first operation acceptor 20 (e.g., the multiple operation buttons) includes a raise button 21a relating to “combination,” a lower button 21b relating to “combination,” a raise button 22a relating to “head,” a lower button 22b relating to “head,” a raise button 23a relating to “feet,” a lower button 23b relating to “feet,” a raise/lower button 24a relating to “height,” a lower button 24b relating to “height,” etc.

For example, when the raise button 22a relating to “head” is pressed, the angle of the back section 70a increases. For example, when the lower button 22b relating to “head” is pressed, the angle of the back section 70a decreases. For example, when the raise button 23a relating to “feet” is pressed, the angles of the upper leg section 70b and the lower leg section 70c increase. For example, when the lower button 23b relating to “feet” is pressed, the angles of the upper leg section 70b and the lower leg section 70c decrease. These angles are, for example, angles from the horizontal plane. For example, when the raise button 24a relating to “height” is pressed, the bed surface becomes higher. For example, when the lower button 24b relating to “height” is pressed, the bed surface becomes lower. For example, when the raise button 21a relating to “combination” is pressed, the “head” and the “feet” change in combination. For example, when the lower button 21b relating to “combination” is pressed, the “head” and the “feet” change in combination. These changes are performed by the operation of the movable part 70. For example, the operations recited above are performed in the period in which the first operation acceptor 20 continues to receive operations (e.g., the period in which the operation buttons continue to be pressed). A safe operation is obtained thereby.

In the example, multiple buttons (a button 25a relating to a first memory position, a button 25b relating to a second memory position, etc.) are provided as the second operation acceptor 25. The number of multiple buttons used as the second operation acceptor 25 may be three or more.

The first memory position is formed when the button 25a is pressed. The second memory position is formed when the button 25b is pressed. The first memory position corresponds to the state of one combination of the states of the back section 70a, the upper leg section 70b, the lower leg section 70c, and the height adjuster 70d. The second memory position corresponds to the state of another one combination of the states of the back section 70a, the upper leg section 70b, the lower leg section 70c, and the height adjuster 70d.

The desired posture can be formed by the second operation acceptor 25 (the button 25a and the button 25b). The desired posture is stored in the memory 48. Further, the order of the movements of the movable part 70 until reaching the desired posture also may be stored. The movable part 70 moves according to the stored order.

The control of the movable part 70 by the second operation acceptor 25 (e.g., the memory button) is simpler than the control of the movable part 70 by the first operation acceptor 20 (e.g., the multiple operation buttons). The ease of use is improved by the second operation acceptor 25 (e.g., the memory button).

For example, the second operation acceptor 25 (e.g., the memory button) is suited to being operated by the user of the electric furniture 310. Further, the second operation acceptor 25 may be operated by a caregiver (a nurse or the like) of the user of the electric furniture 310.

On the other hand, at least a part of the multiple first operation acceptors 20 (e.g., the multiple operation buttons) can independently control the multiple movable parts 70 individually. Thereby, the desired state can be controlled finely. Accordingly, the multiple first operation acceptors 20 are suited to being operated by the caregiver (the nurse or the like).

By providing the second operation acceptor 25 (e.g., the memory button), more proactive movement of the movable part 70 by the user of the electric furniture 310 (e.g., the electric bed) can be promoted. By providing the second operation acceptor 25 in addition to the first operation acceptor 20, for example, the usage is easier for both the user and the caregiver of the user.

The storing of the state of the movable part 70 in the memory 48 may be performed automatically. Or, the storing of the state of the movable part 70 in the memory 48 may be performed manually. For example, the switch 50 is used when manually storing the state of the movable part 70, etc.

For example, an operation mode and a memory mode may be provided in the control device 160. These modes may be switched by the operation of the switch 50. For example, in the operation mode, the movable part 70 is operated by operating the first operation acceptor 20 and the second operation acceptor 25. The mode can be transitioned to the memory mode by operating the switch 50. In the memory mode, the movable part 70 is set to the desired state by operating the first operation acceptor 20. For example, the state of the movable part 70 at that time is stored in the memory 48 by pressing the second operation acceptor 25 (the button 25a or the button 25b) in this state. The mode is returned to the operation mode by pressing the switch 50 again. In the operation mode, the stored state of the movable part 70 is formed by operating the second operation acceptor 25. Thus, in the embodiment, the state of the movable part 70 may be stored using the switch 50.

Other than mode switching such as that recited above, the switch 50 may be used in any control. For example, a hardware switch, a software-controlled switch, etc., can be used as the switch 50.

On the other hand, in the case where the storing of the state of the movable part 70 in the memory 48 is performed automatically, for example, the state of the user of the electric furniture 310 is detected by a detector (described below). The detector may be provided inside the electric furniture 310 or may be provided separately from the electric furniture 310. Then, it is determined (estimated) whether or not the detected state of the user is a prescribed state. The prescribed state is, for example, sitting up, sitting upright (e.g., a bed-exit preparation state), getting out of bed, falling asleep, sleeping, being awake (but lying on the bed 70), etc. When it is determined (estimated) that the state of the user is the prescribed state, the state of the movable part 70 at that time is stored in the memory 48. At this time, the state of the movable part 70 stored automatically in the memory 48 is formed when the second operation acceptor 25 (e.g., the memory button) accepts an operation (e.g., a memory button is pressed).

In the embodiment, the movable part 70 moves automatically (not manually) based on the state of the user detected by the detector.

For example, as recited above, the movable part 70 moves when the first operation acceptor 20 or the second operation acceptor 25 accepts a control operation. This is a manual operation. In the embodiment, the movable part 70 moves based on the state of the user detected by the detector even when the first operation acceptor 20 or the second operation acceptor 25 does not accept a control operation. In other words, a controller 42 (referring to FIG. 1A) is provided in the electric furniture 310. The controller 42 controls the controlled part 70C (in the example, the movable part 70) based on the state of the user detected by the detector. In other words, a “movable part control” in which the movable part 70 is moved based on the state of the user detected by the detector is possible in the controller 42. Thereby, the operation is simpler. Electric furniture can be provided in which the ease of use can be improved.

The automatic operation of the movable part 70 of the embodiment recited above is an automatic mode. For example, the switch 50 may be capable of performing the automatic mode other than the operation mode and the memory mode recited above. For example, the performing and the non-performing of the automatic mode may be switched according to the health condition of the user, etc. Examples of the automatic mode are described below.

For example, any memory device such as a semiconductor memory device, a magnetic memory device, an optical storage device, etc., can be used as the memory 48. The memory 48 may be provided in a location that is different from the location where the electric furniture 310 is provided. For example, a memory device that is provided in a server that can communicate with the electric furniture 310 (including the control device 160) may be used as the memory 48.

For example, the memory 48 is connected to the control device 160 via the controller 42 (e.g., a computer). The controller 42 may be provided in the control device 160. The controller 42 may be provided separately from the control device 160.

As shown in FIG. 1B, a display region 28 may be provided at the first surface 10a. For example, the display region 28 can display information (the height, the angle of the section, etc.) relating to the movable part 70 of the electric furniture 310. The display region 28 may display information relating to the function or operating states of the first operation acceptor 20 (the multiple operation buttons) and the second operation acceptor 25.

Examples of the control of the movable part 70 by the first operation acceptor 20 (e.g., the operation buttons) will now be described.

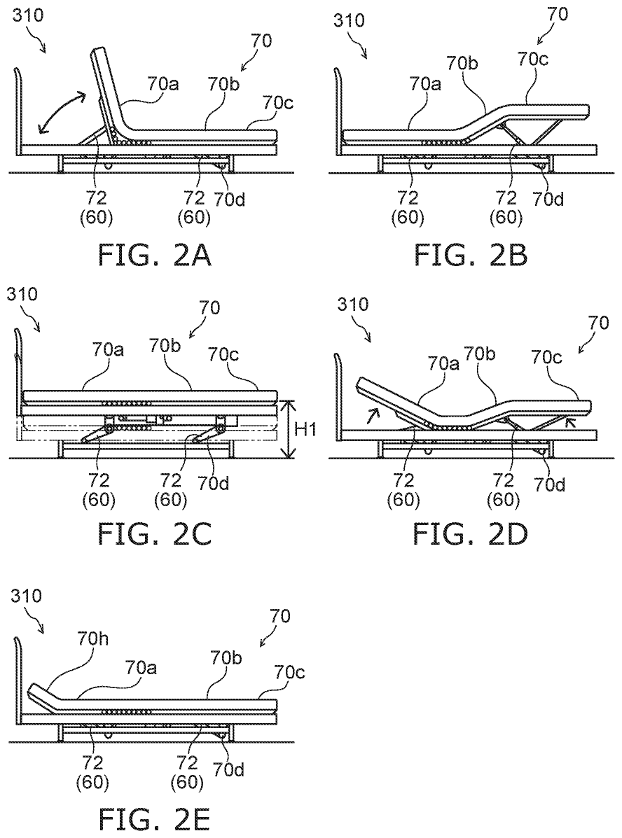

FIG. 2A to FIG. 2E are schematic views illustrating controls of the electric furniture according to the first embodiment.

As shown in FIG. 2A, when the button 22a or the button 22b relating to “head” is operated, the angle of the back section 70a is changed; and the “back-raising operation” or the “back-lowering operation” is performed.

As shown in FIG. 2B, when the button 23a or the button 23b relating to “feet” is operated, the angles of the upper leg section 70b and the lower leg section 70c are changed; and the “knee-raising operation” or the “knee-lowering operation” is performed.

As shown in FIG. 2C, when the button 24a and the button 24b relating to “height” are operated, the movement of the height adjuster 70d is controlled. A height adjustment is performed thereby. In other words, a height H1 of the bed surface is modified.

As shown in FIG. 2D, when the button 21a and the button 21b relating to “combination” are operated, the angles of the back section 70a, the upper leg section 70b, and the lower leg section 70c are changed in combination. The height H1 may be changed in combination.

As shown in FIG. 2E, a head section 70h may be further provided. The angle of the head is modifiable by the operation of the head section 70h.

On the other hand, the first memory position (a first posture) is formed when the second operation acceptor 25 receives an operation (e.g., when the button 25a or the button 25b is operated). The first memory position is one combination of the states of the back section 70a, the upper leg section 70b, the lower leg section 70c, and the height adjuster 70d. For example, when the second operation acceptor 25 receives an operation, the back section 70a, the upper leg section 70b, the lower leg section 70c, and the height adjuster 70d may be moved according to the stored order. The head section 70h may be controlled further by the operation of the second operation acceptor 25 (the button 25a or the button 25b). In such a case as well, the order of the movement of the head section 70h may be stored.

For example, information relating to the state and the order of the operations relating to at least one of “back-raising,” “knee-raising,” “height adjustment,” “tilting,” or the like is stored. For example, the movable part 70 that relates to at least one of “back-raising,” “knee-raising,” “height adjustment,” “tilting,” or the like is controlled based on the stored information, “Tilting” includes at least one of rolling or tilting.

As shown in FIG. 2A to FIG. 2E, a driver 72 (e.g., an actuator) is provided in the electric furniture 310. The movable part 70 is moved by the operation of the driver 72.

In the example, the driver 72 includes a load sensor. The state of the user of the electric furniture 310 can be detected using the load applied to the load sensor (the driver 72). For example, the states of the user sitting up, sitting upright, getting out of bed, falling asleep, sleeping, being awake, etc., can be estimated based on the load applied to the part (e.g., the back section 70a) of the electric furniture 310 corresponding to the upper body, the load applied to the parts (e.g., the upper leg section 70b and the lower leg section 70c) of the electric furniture 310 corresponding to the lower body, etc.

The example corresponds to a detector 60 being provided in the driver 72 driving the movable part 70. Thus, the detector 60 may be included in the driver 72.

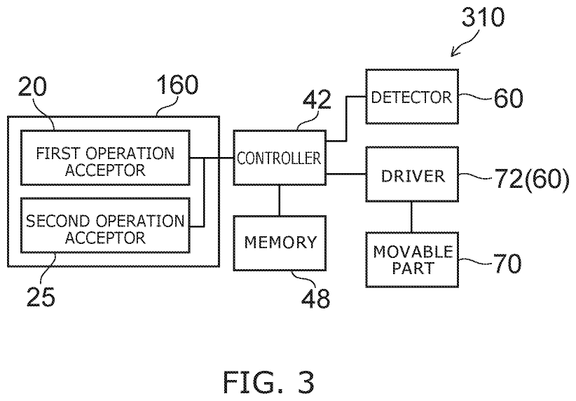

FIG. 3 is a block diagram illustrating the electric furniture according to the first embodiment.

As shown in FIG. 3, the first operation acceptor 20 and the second operation acceptor 25 recited above are provided in the control device 160. The first operation acceptor 20 and the second operation acceptor 25 are connected to the controller 42. The memory 48 and the driver 72 are connected to the controller 42. The movable part 70 is driven by the driver 72. As described above, at least a part of the driver 72 (e.g., the actuator) is considered to be the detector 60 in the case where the driver 72 includes a load sensor. As described below, the detector 60 may be provided separately from the driver 72.

For example, the user of the electric furniture 310 or the caregiver of the user operates the first operation acceptor 20. A signal that corresponds to the operation accepted by the first operation acceptor 20 is supplied to the driver 72 via the controller 42. The movable part 70 is moved by the driver 72 receiving the signal and driving the movable part 70.

The user state information and the movable part information are stored in the memory 48. The user state information is information (e.g., a database) relating to the state of the user. The movable part information is information (e.g., a database) relating to the state of the movable part. The movable part information is associated with the user state information. For example, one piece of movable part information (a direction relating to one state of the movable part 70) is stored to correspond to one piece of user state information.

As necessary, the controller 42 extracts the information stored in the memory 48 and performs processing. For example, the determination (the estimation) of the state of the user is performed using the user state information stored in the memory 48. When it is determined (estimated) that the state of the user is a designated state, the control of the movable part 70 (the “movable part control”) is performed based on the movable part information stored in the memory 48. As described above, for example, the movable part information is stored in the memory 48 manually or automatically.

On the other hand, for example, the state of the user is detected by the detector 60 (in the example, the driver 72). The signal that corresponds to the state of the user detected by the detector 60 is supplied to the controller 42. Whether or not the detected state of the user is a prescribed state is determined (estimated) by the controller 42. For example, in the case where the state of the user detected by the detector 60 is a prescribed state, the controller 42 moves the movable part 70 based on the movable part information stored in the memory 48. For example, when it is determined that the state of the user is a prescribed state (e.g., sleeping, etc.), the movable part 70 moves toward a state suited to sleeping.

For example, in the case where the state of the user is sleeping, it is dangerous for the user to fall from the bed surface if the bed surface is high. In the case where the state of the user is sleeping, the safety of the user is improved by lowering the bed surface.

For example, there is a facility such as a hospital or the like that houses many patients (or non-care person). In such a facility, a nurse or a caregiver performing the work of lowering the bed surface to ensure the safety when sleeping would be an extremely large amount of labor.

In the embodiment, for example, when the state of the user is sleeping, the state is determined; and the bed surface is lowered automatically. The burden of the nurse or the caregiver is reduced thereby.

Examples of the states of the user determined in the embodiment are described below.

The block diagram illustrated in FIG. 3 illustrates functional blocks. Multiple functions may be performed by one circuit. For example, at least a part of the function of the controller 42 may be performed by the detector 60.

The detection of the state of the user is performed by the detector 60. For example, the determination (the estimation) of whether or not the detected state is a prescribed state is performed by the controller 42. At least a part of the determination (the estimation) of whether or not the detected state is the prescribed state may be performed by at least a part of the detector 60 and the memory 48.

The state of the user is detected by the detector 60 (e.g., the load sensor-including actuator which is the driver 72). Then, it is determined whether or not the detection result is the designated state.

In the case where the electric furniture 310 is an electric bed, the designated state is, for example, one of sitting up, sitting upright, getting out of bed, falling asleep, sleeping, being awake, or the like. For example, in the case where the detector 60 is multiple load sensor-including actuators, it can be determined (estimated) that the user is at least one state of sitting up, sitting upright, getting out of bed, falling asleep, sleeping, being awake, or the like from the loads applied to each of the multiple load sensors.

For example, sitting upright or getting out of bed is discriminated based on the change (the reduction amount) of the load. For example, “sitting up” can be estimated from the difference between the load at the part of the electric bed corresponding to the upper body and the load at the part of the electric bed corresponding to the lower body, etc. Sitting upright is estimated in the case where the load at a part of the side of the electric bed is locally large. Getting out of bed is estimated in the case where the load is small for any location of the electric bed. Falling asleep or sleeping can be estimated in the case where relatively the same load is applied to the multiple load sensors. As described below, various configurations (e.g., a detector of a biological signal, etc.) can be used as the detector 60; and the various states of the user can be estimated thereby.

Thus, the state of the user may be determined (estimated) by classifying into multiple states. The number of classifications of the states is, for example, n (n being an integer of 2 or more). For example, it is determined (estimated) whether or not the state of the user detected by the detector 60 is the first to nth user states. The first to nth user states are respectively, for example, one of sitting up, sitting upright, getting out of bed, falling asleep, sleeping, being awake, or the like.

For example, in the case where it is determined that the state of the user is sitting up, the back section 70a is set to a prescribed angle suited to sitting up. For example, in the case where it is determined (estimated) that the state of the user is getting out of bed, the height adjuster 70d is set to a prescribed height suited to getting out of bed. For example, in the case where it is determined (estimated) that the state of the user is sleeping, for example, the height adjuster 70d is lowered to be safe even if the user falls from the bed surface. In the case where the state of the user is sitting upright, for example, the height adjuster 70d is set to a prescribed height suited to standing up. Such a control of the movable part 70 is performed by the driver 72 being controlled by a control of the controller 42.

In the embodiment, other than sitting up, sitting upright, getting out of bed, falling asleep, sleeping, being awake, etc., the state of the user may be any state.

In the embodiment, at least a part of the movable part state stored in the memory 48 may be initializable (settable to an initial value). The stored data may be initialized collectively or individually. For example, in the case where the state of the movable part 70 formed by the operation of the second operation acceptor 25 is stored in the memory 48, the stored state of the movable part 70 may be initialized collectively or individually.

Several examples of the state of the movable part 70 (i.e., the state of the electric furniture 310) formed based on the state of the movable part 70 stored in the memory 48 will now be described.

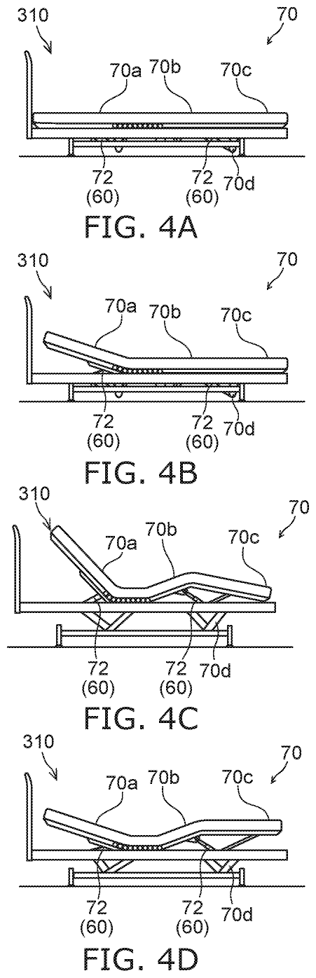

FIG. 4A to FIG. 4D are schematic views illustrating states of the electric furniture according to the first embodiment.

These examples are when the electric furniture 310 is an electric bed.

In the example shown in FIG. 4A, the height of the bed surface is low. For example, particularly in the case where a senior citizen or the like is the user, when the state of the user is falling asleep (or sleeping), it is dangerous for the user to fall from the bed while sleeping if the bed surface is high. The safety is improved by lowering the bed surface. The movable part 70 (the height adjuster 70d) is set to such a state in which the bed surface is low when the user state is sleeping. Thus, the controller 42 lowers the height of the height adjuster 70d when the state of the user is the sleeping state. For example, the height of the bed surface is set to a minimum controllable height.

There are cases where the user attempts to stand up when the state of the user is sitting upright. In such a case, the bed surface is set to a designated height (the sitting-upright height) by the movement of the movable part 70 (the height adjuster 70d). The sitting-upright height is higher than the minimum controllable height. The sitting-upright height may be adjustable according to the physique of the user, etc. For example, after setting the mode to a memory mode, the height may be adjusted to the appropriate height by operating the first operation acceptor 20; and the height may be stored in the memory 48 as the sitting-upright height. The movable part 70 (the height adjuster 70d) is adjusted to the sitting-upright height by reading the data from the memory 48. Thus, the controller 42 may adjust the height of the height adjuster 70d to the sitting-upright height when the state of the user is sitting upright.

As shown in FIG. 4B, in the case where the state of the user detected by the detector 60 is falling asleep, first, the back section 70a is tilted. Subsequently, in the case where the state of the user detected by the detector 60 is sleeping, the tilt of the back section 70a is reduced and approaches horizontal. The angle (the angle from the horizontal direction) of the back section 70a formed when the state of the user is falling asleep is, for example, not less than 4 degrees but less than 24 degrees. It is easy to transition from the awake state to the sleeping state at such an angle. In other words, falling asleep is performed smoothly; and the transition to the sleeping state can be quick. Comfortable and natural falling asleep and sleeping of the user is induced thereby.

Thus, the controller 42 tilts the back section 70a when the state of the user detected by the detector 60 is falling asleep. The controller 42 changes the back section 70a toward horizontal when sleeping after the state of the user detected by the detector 60 was falling asleep. It is favorable for the angle of the tilt of the back section recited above to be, for example, not less than 4 degrees but less than 24 degrees. Also, it is favorable for the controller 42 to set the angle of the back section 70a when sleeping after the state of the user is falling asleep to be less than 4 degrees. A good sleep posture is obtained thereby.

In the example shown in FIG. 4C, the angle of the back section 70a is large; the angles of the upper leg section 70b and the lower leg section 70c are about medium; and the bed surface is high. For example, such a posture is formed when the state of the user is sitting up. For example, such a posture is favorable when watching television, etc. The controller 42 sets the angle of the back section 70a to be large when the state of the user detected by the detector 60 is sitting up. The controller 42 also may operate the upper leg section 70b, the lower leg section 70c, and the height adjuster 70d.

The posture illustrated in FIG. 4C is one of the postures formed by the electric furniture 310. There are cases where one such posture causes a burden on the body when continued for a long period of time. For example, symptoms such as “bedsores,” etc., occur. At such a time, the controller 42 may appropriately modify the posture.

For example, in the example shown in FIG. 4D, the angles of the back section 70a, the upper leg section 70b, and the lower leg section 70c are about medium; and the bed surface is high. For example, in the case where a posture such as that shown in FIG. 4C is continued for not less than a constant and the state of the body of the user is not changed very much in the period, the posture may be transitioned to a posture such as that shown in FIG. 4D, Then, after the posture of FIG. 4D, a posture such as that shown in FIG. 4C may be formed again.

In the embodiment, for example, the speed of the movable part 70 when the movable part 70 moves automatically may be different from the speed of the movable part 70 when the movable part 70 is moved manually. For example, the speed of the movable part 70 when the movable part 70 moves automatically may be slower than the speed of the movable part 70 when the movable part 70 is moved manually. For example, there is a possibility that a dangerous state may occur if the speed of the change of the posture is fast when the change is performed automatically. For example, if the change of the posture is excessively fast, there is a possibility that a state may occur in which the body of the user is pinched between the frame (including the siderail, the grip, etc.) of the electric furniture 310, etc. Further, the user is startled when the change of the posture is excessively fast. By setting the speed of the movable part 70 when the movable part 70 moves automatically to be slow, the safety is improved; and peace of mind is provided to the user.

For example, as recited above, the control device 160 that includes the operation acceptor (the first operation acceptor 20 or the like) is provided in the electric furniture 310. As described above, the movable part 70 moves according to the control operation accepted by the operation acceptor (the first operation acceptor 20). At this time, for example, the speed when the movable part 70 moves based on the state of the user detected by the detector 60 is different from the speed when the movable part 70 moves according to the control operation accepted by the operation acceptor. At least one of these speeds may be modifiable (settable). For example, the control of the modification of such speeds is performed by the controller 42.

For example, the state of the user detected by the detector 60 may include the case where there is no human (e.g., no user or the like) on the bed (the electric furniture 310). In the case where there is no human (e.g., no user or the like) on the bed, the speed when the movable part 70 moves may be different from the speed when the movable part 70 moves according to the control operation accepted by the operation acceptor. In the case where there is no human (e.g., no user or the like) on the bed, the speed when the movable part 70 moves may be faster than the speed when the movable part 70 moves according to the control operation accepted by the operation acceptor.

In the embodiment as recited above, the movable part 70 moves automatically (not manually) based on the state of the user detected by the detector 60. At this time, there is a danger that the user may be pinched in the movable part 70 moving automatically, etc. Therefore, for example, means to ensure the safety such as the following may be provided.

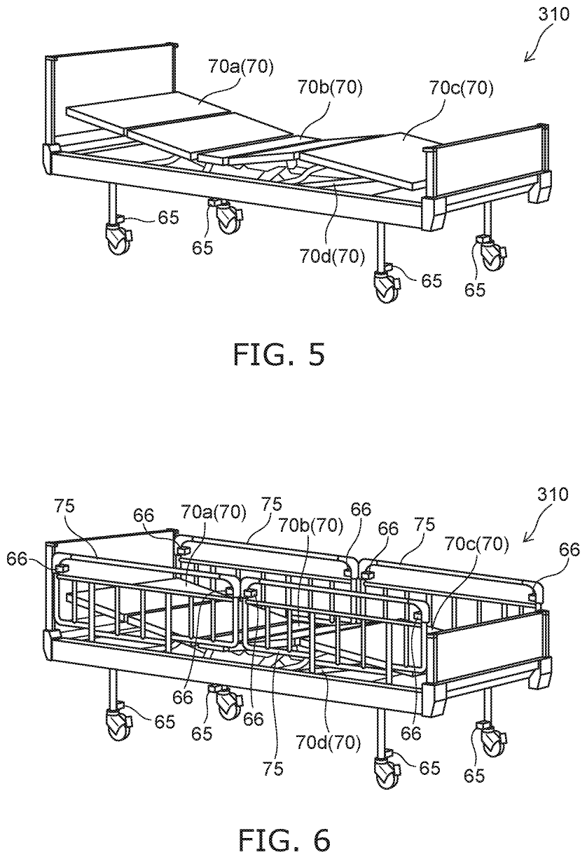

FIG. 5 is a schematic perspective view illustrating the electric furniture according to the first embodiment.

As shown in FIG. 5, the electric furniture 310 includes a floor part sensor 65. The floor part sensor 65 detects an object existing in the space between the movable part 70 and the floor (the floor where the electric furniture 310 is installed). The floor part sensor 65 includes, for example, an infrared sensor, an ultrasonic sensor, etc.

For example, in the case where the body (a foot, etc.) of the user, the caregiver, or the like is under the bed surface of the electric furniture 310, the body is detected by the floor part sensor 65. The output signal of the floor part sensor 65 is supplied to the controller 42 (not illustrated in FIG. 5).

The controller 42 does not perform the “movable part control” recited above when the floor part sensor 65 detects the object (the body, etc.) existing in the space between the movable part 70 and the floor. As described above, the “movable part control” is a control of moving the movable part 70 based on the state of the user detected by the detector 60. When the object (the body or the like) is detected, for example, the movable part 70 does not move. Or, a control that is different from the “movable part control” recited above is performed. For example, the width (the distance) of the movement of the movable part 70 is narrower than the width (the distance) of the movement of the “movable part control” recited above. An unsafe movement of the movable part 70 can be suppressed thereby.

FIG. 6 is a schematic perspective view illustrating the electric furniture according to the first embodiment.

As shown in FIG. 6, a frame 75 (including a siderail, a grip, etc.) is provided in the electric furniture 310. By providing the frame 75, the user that is sleeping on the electric furniture 310 (in the example, the electric bed) can be suppressed from falling from the electric bed.

The electric furniture 310 includes a frame part sensor 66. The frame part sensor 66 detects an object existing in the space between the frame 75 and the movable part 70. The object includes, for example, the body of the user or the caregiver. The frame part sensor 66 includes, for example, an infrared sensor, an ultrasonic sensor, etc. The frame part sensor 66 may detect an overload received by the actuator (the movable part 70). For example, there are cases where the load applied to the actuator becomes excessively large when an object is pinched in the frame 75, etc. The pinched object can be detected by detecting the overload. The output signal of the frame part sensor 66 is supplied to the controller 42 (not illustrated in FIG. 6).

When the frame part sensor 66 detects the object existing in the space between the frame 75 and the movable part 70, the controller 42 does not perform the “movable part control” recited above. When the object (the body or the like) is detected, for example, the movable part 70 does not move. Or, a control that is different from the “movable part control” recited above is performed. For example, the width (the distance) of the movement of the movable part 70 is narrower than the width (the distance) of the movement of the “movable part control” recited above. An unsafe movement of the movable part 70 can be suppressed thereby.

For example, an alarm (a sound, a vibration, a display, etc.) may be emitted when the floor part sensor 65 or the frame part sensor 66 detects the object (the body, etc.). Thereby, the cause of the movable part 70 not moving can be designated; and the user, the caregiver, etc., can remove the cause.

### Second Embodiment

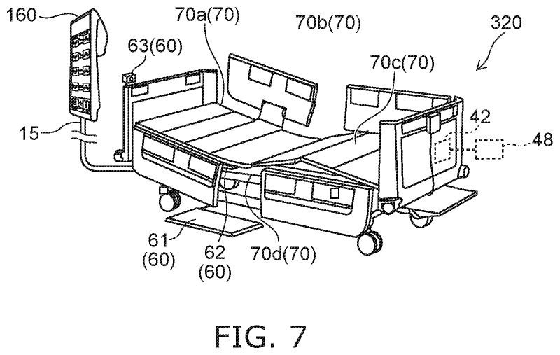

FIG. 7 is a schematic perspective view illustrating electric furniture according to a second embodiment.

As shown in FIG. 7, the electric furniture 320 according to the embodiment also includes the movable part 70, the detector 60, and the controller 42. In the example as well, the detector 60 detects the state of the user. A movable part control in which the movable part 70 is moved based on the state of the user detected by the detector 60 is possible in the controller 42. In the embodiment, a body sensor 63 is provided as the detector 60. The body sensor 63 can detect the position of the body of the user. For example, an image sensor (e.g., a camera), etc., can be used as the body sensor 63. The image sensor acquires images of the user, the electric furniture 320, and the periphery of the user and the electric furniture 320. The relative relationship between the position of the body of the user and the position of the electric furniture 320 can be detected based on the images. The detection result (the output signal) of the body sensor 63 is supplied to the controller 42.

When the body sensor 63 detects at least a part of the body overlapping the electric furniture 320, the “movable part control” recited above is not performed. For example, the movable part 70 does not move. Or, a control that is different from the “movable part control” recited above is performed. For example, when at least a part of the body is detected to overlap the electric furniture 320, the width (the distance) of the movement of the movable part 70 is narrower than the width (the distance) of the movement of the “movable part control” recited above. An unsafe movement of the movable part 70 can be suppressed thereby.

For example, an alarm (a sound, a vibration, a display, etc.) may be emitted when the body sensor 63 detects an overlap of the body and the electric furniture 320. Thereby, the cause of the movable part 70 not moving can be designated; and the user, the caregiver, etc., can remove the cause.

The state of the user also can be determined (estimated) based on the detection result of the body sensor 63 (the image sensor). In such a case, the body sensor 63 is used as at least a part of the detector 60.

Another example of the detector 60 also is shown in FIG. 7.

As shown in FIG. 7, a sheet-type bed-exit sensor 61 may be provided in the electric furniture 320. For example, when the user of the electric furniture 320 (in the example, the electric bed) gets up from the electric bed and mounts the bed-exit sensor 61, the body weight of the user is applied to the bed-exit sensor 61. The bed-exit sensor 61 detects the load due to the body weight. Thereby, the bed-exit sensor 61 can detect the user getting out of bed.

In the electric furniture 320, a sensor 62 may be provided in the electric bed. In the case where the sensor 62 can detect the load (the pressure), the sensor 62 may be provided at each of multiple locations of the electric bed. The body weight (the load) of the user of the electric bed is detected by the sensor 62. Thereby, the sensor 62 can detect (estimate) the various states of the user.

The sensor 62 may be capable of detecting at least one of the pulse, the breathing, or the body temperature of the user. The state of the user can be detected (estimated) using these values and changes of these values.

The bed-exit sensor 61, the sensor 62, and the body sensor 63 (the image sensor) are examples of the detector 60. Various modifications of the detector 60 are possible.

Several examples of the sensor 62 will now be described.

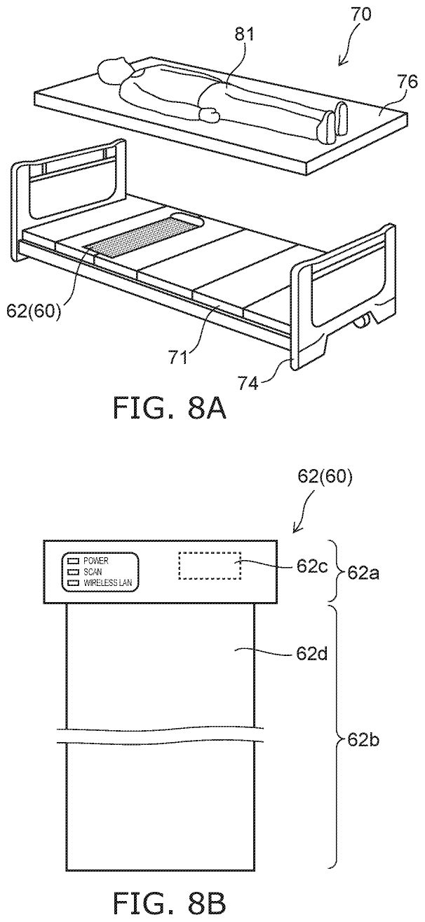

FIG. 8A and FIG. 8B are schematic views illustrating the electric furniture according to the second embodiment. FIG. 8A is a schematic perspective view illustrating the sensor 62 and the arrangement of the sensor 62. FIG. 8B is a schematic plan view illustrating the sensor 62. In FIG. 8A, the components are drawn as being separated from each other for easier viewing of the drawing.

As shown in FIG. 8A, a section 71 is provided on a bed leg part 74 of the bed 70. A mattress 76 is provided on the section 71. A user 81 lies on the mattress 76. The sensor 62 (the detector 60) is provided between the section 71 and the mattress 76. In the example, the sensor 62 has a sheet configuration or a plate configuration.

As shown in FIG. 8B, the sensor 62 includes a circuit part 62a and a sensor part 62b. The circuit part 62a includes a communicator 62c. The communicator 62c performs the transmission and reception of data with the controller 42. The transmission and reception is performed by any method including at least one of wired or wireless.

The sensor part 62b includes, for example, a sensor device 62d. The sensor part 62b detects a force (or a characteristic corresponding to a force) received by the sensor part 62b. The force includes, for example, at least one of pressure or a sound wave. The sensor part 62b includes, for example, a pressure sensor. The sensor part 62b includes, for example, a microphone.

A force (at least one of pressure or a sound wave) due to the user 81 is applied to the sensor part 62b via the mattress 76. For example, a signal based on the force detected by the sensor part 62b is output from the circuit part 62a. The output signal is supplied to the controller 42. In the controller 42, the state of the user 81 (getting out of bed, sleeping, being awake, or the like) is estimated based on at least one of the intensity of the signal (the force) or the temporal change of the intensity of the signal (the force). Or, in the circuit part 62a, the state of the user 81 (getting out of bed, sleeping, being awake, etc.) may be estimated based on at least one of the force or the temporal change of the force detected by the sensor part 62b. The state of the user 81 may include sitting up, sitting upright (e.g., a bed-exit preparation state), getting out of bed, falling asleep, sleeping, or being awake.

For example, a vibration that corresponds to the state of the user 81 is applied to the sensor part 62b. For example, the vibration corresponds to the body movement of the user 81. The vibration is detected by the sensor part 62b. The vibration may include a sound.

For example, a vibration detection portion (the sensor part 62b) and a processor (at least a part of at least one of the circuit part 62a or the controller 42) are provided. For example, the processor includes a computer. For example, the vibration detection portion detects the vibration of a sleeper (the user 81) on bedding (the bed 70). The processor includes, for example, an activity amount calculation portion, a sleep determination value calculation portion, and a sleeping state determination portion. These means are divided functionally. For example, the activity amount calculation portion calculates the activity amount of the sleeper based on the vibration detected by the vibration detection portion every unit sampling time. For example, the sleep determination value calculation portion calculates, as the sleep determination value, the sum total of the values of correction coefficients weighted according to time multiplied by the activity amount at a first time (e.g., the current time) and the activity amount calculated at a second time (e.g., a time before the current time). For example, the sleeping state determination portion determines the state to be the awake state in the case where the sleep determination value exceeds a prescribed threshold and determines the state to be the sleeping state otherwise.

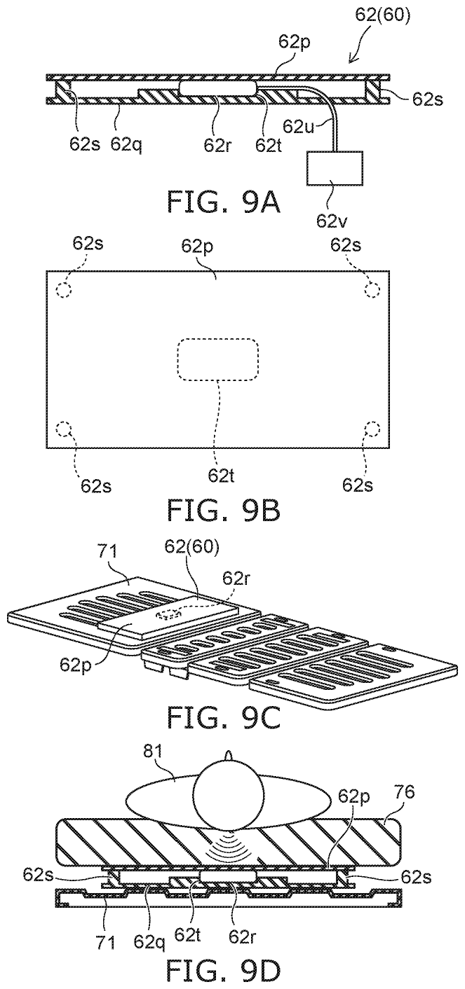

FIG. 9A to FIG. 9D are schematic views illustrating another electric furniture according to the second embodiment.

FIG. 9A is a cross-sectional view of an example of the sensor 62. FIG. 9B is a plan view of the example of the sensor 62. FIG. 9C is a perspective view illustrating the arrangement of the sensor 62. FIG. 9D is a side view illustrating the arrangement of the sensor 62.

In the example as shown in FIG. 9A, the sensor 62 includes a first plate body 62p and a second plate body 62q. The second plate body 62q opposes the first plate body 62p. These plate bodies may have sheet configurations.

The second plate body 62q includes a support protrusion 62s. The support protrusion 62s opposes the outer edge part of the first plate body 62p. The first plate body 62p includes an inner part inside the outer edge part. An air container 62r is provided between the inner part and the second plate body 62q. In the example, a groove 62t is provided in the second plate body 62q. The air container 62r is provided in the space (the divided space) formed of the groove 62t. One end of a signal line 62u is connected to the air container 62r. The other end of the signal line 62u is connected to a detection circuit 62v (a detection device).

As shown in FIG. 9B, the support protrusion 62s opposes a part of the outer edge of the first plate body 62p. In the example, the support protrusion 62s is provided at the four corner parts of the first plate body 62p. The sensor 62 has a sheet configuration or a plate configuration.

As shown in FIG. 9C, the sensor 62 recited above is placed on the section 71. As shown in FIG. 9D, the sensor 62 is placed on the section 71; and the mattress 76 is placed on the sensor 62. The user 81 lies on the mattress 76.

For example, a force that corresponds to the movement of the body of the user 81 is applied to the air container 62r. The force includes, for example, a vibration. The force (or a characteristic corresponding to the force) that is applied to the air container 62r is detected by the detection circuit 62v. For example, a pressure detector is provided in the air container 62r; and a signal (a detection result) that is obtained by the pressure detector is supplied to the detection circuit 62v. For example, a microphone is provided in the air container 62r; and a signal (a detection result) that is obtained by the microphone is supplied to the detection circuit 62v. For example, the output (the signal) of the detection circuit 62v is supplied to the controller 42. The state of the user 81 (getting out of bed, sleeping, being awake, or the like) is estimated in the controller 42. Or, the state of the user 81 (getting out of bed, sleeping, being awake, etc.) may be estimated by the detection circuit 62v based on at least one of the detected force or the temporal change of the force. The state of the user 81 may include sitting up, sitting upright (e.g., a bed-exit preparation state), getting out of bed, falling asleep, sleeping, or being awake.

The sensor 62 is, for example, a living body information collection device. The first plate body 62p of the sensor 62 is disposed, for example, on the body side of the user 81. For example, the second plate body 62q is provided on the support side. The deformable air container 62r for detecting air pressure is provided between the central parts of the first plate body 62p and the second plate body 62q. The groove 62t where the air container 62r is mounted is provided in the central part of the second plate body 62q. The support protrusion 62s protrudes in a direction from the second plate body 62q toward the first plate body 62p. The support protrusion 62s supports the four corners of the periphery of the first plate body 62p. For example, the support protrusion 62s constantly supports the first plate body 62p in the horizontal state (the normal state).

In the embodiment, various modifications of the sensor 62 are possible.

In the embodiment, the controller 42 may control at least one of the illuminator 73a or the temperature controller 73b (referring to FIG. 1A) as the controlled part 70C based on the state of the user 81 detected by the detector 60. For example, the brightness of the illuminator 73a may be modified (e.g., including ON/OFF) based on the state of the user 81 (at least one of sitting up, sitting upright (e.g., a bed-exit preparation state), getting out of bed, falling asleep, sleeping, or being awake) detected by the sensor 62. For example, the direction of the light emitted from the illuminator 73a may be modified based on the state of the user 81 detected by the sensor 62. The illuminator 73a includes, for example, at least one of a reading lamp or a foot lamp. For example, the temperature of the temperature controller 73b may be modified (e.g., including ON/OFF) based on the state of the user 81 detected by the sensor 62. Electric furniture can be provided in which the ease of use can be improved.

### Third Embodiment

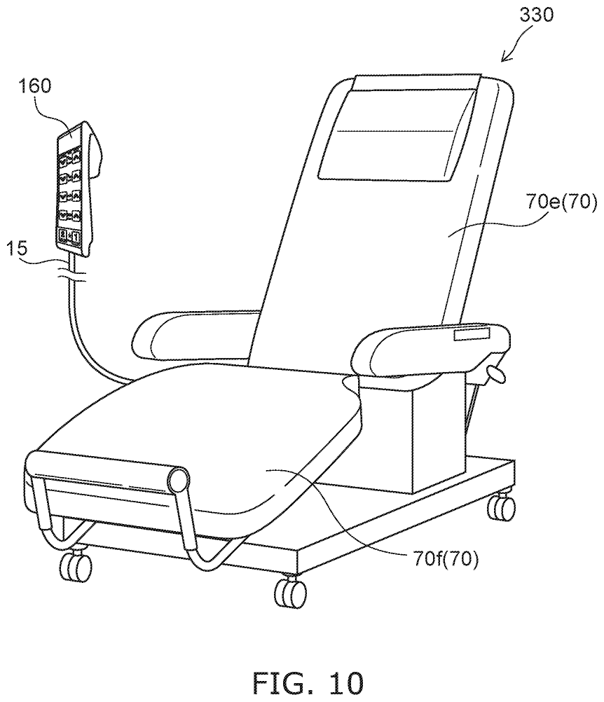

FIG. 10 is a schematic perspective view illustrating electric furniture according to a third embodiment.

As shown in FIG. 10, the electric furniture 330 is an electric reclining chair. The electric furniture 330 includes the movable part 70. The movable part 70 includes, for example, a backrest part 70e and a seat surface part 70f. The backrest part 70e corresponds to a bottom part having a modifiable angle. The seat surface part 70f corresponds to the height adjuster. The angle of the seat surface part 70f may be modifiable. These movable parts 70 are controlled by the control device 160 according to the embodiment. In the electric furniture 330 as well, the movable part 70 moves according to the state of the user.

The embodiments may include the following configurations (proposals).

### Configuration 1

Electric furniture, comprising:

a controlled part;

a detector detecting a state of a user; and

a controller controlling the controlled part based on the state of the user detected by the detector.

### Configuration 2

The electric furniture according to Configuration 1, wherein

the controlled part includes a movable part, and

the controller performs a movable part control of moving the movable part based on the state of the user detected by the detector.

### Configuration 3

The electric furniture according to Configuration 2, wherein

the movable part includes a height adjuster, and

the controller lowers a height of the height adjuster when the state of the user is a sleeping state.

### Configuration 4

The electric furniture according to Configuration 2, wherein

the movable part includes a height adjuster, and

the controller adjusts a height of the height adjuster to be a sitting-upright height when the state of the user is sitting upright.

### Configuration 5

The electric furniture according to any one of Configurations 2 to 4, further comprising a floor part sensor detecting an object existing in a space between the movable part and a floor,

the controller not performing the movable part control when the floor part sensor detects the object in the space between the movable part and the floor.

### Configuration 6

The electric furniture according to any one of Configurations 2 to 5, wherein

the movable part includes a back section,

the controller tilts the back section when the state of the user is falling asleep, and

the controller changes the back section toward horizontal when the state of the user is sleeping after the falling asleep.

### Configuration 7

The electric furniture according to Configuration 6, wherein

an angle of the tilt of the back section is not less than 4 degrees but less than 24 degrees, and

the controller sets an angle of the back section to be less than 4 degrees when the state of the user is the sleeping after the falling asleep.

### Configuration 8

The electric furniture according to any one of Configurations 2 to 5, wherein

the movable part includes a back section, and

the controller increases an angle of the back section when the state of the user is sitting up.

### Configuration 9

The electric furniture according to any one of Configurations 2 to 8, further comprising:

a frame; and

a frame part sensor detecting an object existing in a space between the frame and the movable part,

the controller not performing the movable part control when the frame part sensor detects the object in the space between the frame and the movable part.

### Configuration 10

The electric furniture according to any one of Configurations 2 to 9, further comprising a body sensor detecting a position of a body of the user,

the controller not performing the movable part control when the body sensor detects at least a part of the body overlapping the electric furniture.

### Configuration 11

The electric furniture according to any one of Configurations 2 to 10, further comprising a control device including an operation acceptor,

the movable part moving according to a control operation accepted by the operation acceptor,

a speed when the movable part moves based on the state of the user detected by the detector being different from a speed when the movable part moves according to the control operation accepted by the operation acceptor.

### Configuration 12

The electric furniture according to any one of Configurations 2 to 11, further comprising memory storing user state information and movable part information, the user state information relating to the state of the user, the movable part information relating to a state of the movable part corresponding to the user state information,

the controller moving the movable part based on the movable part information stored in the memory.

### Configuration 13

The electric furniture according to Configuration 12, wherein the movable part information stored in the memory is initializable.

According to the embodiments, electric furniture can be provided in which the ease of use can be improved.

Hereinabove, embodiments of the invention are described with reference to specific examples. However, the invention is not limited to these specific examples. For example, one skilled in the art may similarly practice the invention by appropriately selecting specific configurations of components included in the electric furniture such as the first operation acceptor, the operation button, the second operation acceptor, the memory button, the switch, the display region, the detector, the movable part, the driver, the controller, the memory, etc., from known art; and such practice is within the scope of the invention to the extent that similar effects can be obtained.

Any two or more components of the specific examples can be combined within the extent of technical feasibility and are within the scope of the invention to the extent that the spirit of the invention is included.

Also, all electric furniture practicable by an appropriate design modification by one skilled in the art based on the electric furniture described above as embodiments of the invention also are within the scope of the invention to the extent that the spirit of the invention is included.

Further, various modifications and alterations within the spirit of the invention will be readily apparent to those skilled in the art; and all such modifications and alterations should be seen as being within the scope of the invention.

### REFERENCE NUMERAL LIST

10 operation part
10a 10b first and second surfaces
15 cable
20 first operation acceptor
21a, 21b, 22a, 22b, 23a, 23b, 24a, 24b buttons
25 second operation acceptor
25a, 25b buttons
28 display region
42 controller
48 memory
50 switch
60 detector
61 bed-exit sensor
62 sensor
62a circuit part
62b sensor part
62c communicator
62d sensor device
62p first plate body
62q second plate body
62r air container
62s support protrusion
62t groove
62u signal line
62v detection circuit
63 body detector
65 floor part detector
66 frame part detector
70 movable part
70C controlled part
70a back section
70b upper leg section
70c lower leg section
70d height adjuster
70e backrest part
70f seat surface part
70h head section
71 section
72 driver
73a illuminator
73b temperature controller
74 bed leg part
75 frame
76 mattress
81 user
160 control device
310 320, 330 electric furniture
H1 height

1. Electric furniture, comprising:
a controlled part;
a detector detecting a state of a user; and
a controller controlling the controlled part based on the state of the user detected by the detector.

2. The electric furniture according to claim 1, wherein
the controlled part includes a movable part, and
the controller performs a movable part control of moving the movable part based on the state of the user detected by the detector.

3. The electric furniture according to claim 2, wherein
the movable part includes a height adjuster, and
the controller lowers a height of the height adjuster when the state of the user is a sleeping state.

4. The electric furniture according to claim 2, wherein
the movable part includes a height adjuster, and
the controller adjusts a height of the height adjuster to be a sitting-upright height when the state of the user is sitting upright.

5. The electric furniture according to claim 2, further comprising a floor part sensor detecting an object existing in a space between the movable part and a floor,
the controller not performing the movable part control when the floor part sensor detects the object in the space between the movable part and the floor.

6. The electric furniture according to claim 2, wherein
the movable part includes a back section,
the controller tilts the back section when the state of the user is falling asleep, and
the controller changes the back section toward horizontal when the state of the user is sleeping after the falling asleep.

7. The electric furniture according to claim 6, wherein
an angle of the tilt of the back section is not less than 4 degrees but less than 24 degrees, and
the controller sets an angle of the back section to be less than 4 degrees when the state of the user is the sleeping after the falling asleep.

8. The electric furniture according to claim 2, wherein
the movable part includes a back section, and
the controller increases an angle of the back section when the state of the user is sitting up.

9. The electric furniture according to claim 2, further comprising:
a frame; and
a frame part sensor detecting an object existing in a space between the frame and the movable part,
the controller not performing the movable part control when the frame part sensor detects the object in the space between the frame and the movable part.

10. The electric furniture according to claim 2, further comprising a body sensor detecting a position of a body of the user,
the controller not performing the movable part control when the body sensor detects at least a part of the body overlapping the electric furniture.

11. The electric furniture according to claim 2, further comprising a control device including an operation acceptor,
the movable part moving according to a control operation accepted by the operation acceptor,
a speed when the movable part moves based on the state of the user detected by the detector being different from a speed when the movable part moves according to the control operation accepted by the operation acceptor.

12. The electric furniture according to claim 2, further comprising memory storing user state information and movable part information, the user state information relating to the state of the user, the movable part information relating to a state of the movable part corresponding to the user state information,
the controller moving the movable part based on the movable part information stored in the memory.

13. The electric furniture according to claim 12, wherein the movable part information stored in the memory is initializable.
